(19) United States
(12) Patent Application Publication
(10) Pub. No.: US 2005/0027587 A1
(43) Pub. Date: Feb. 3, 2005

(54) System and method for determining object effectiveness

(76) Inventors: Richard Edward Latona, Atlanta, GA (US); Lance Michael Blundell, Atlanta, GA (US)

Correspondence Address: FISH & RICHARDSON P.C., 1425 K STREET, N.W., 11TH FLOOR, WASHINGTON, DC, 20005-3500, US

(21) Appl. No.: 10/902,834

(22) Filed: Aug. 2, 2004

Related U.S. Application Data
(60) Provisional application No. 60/492,117, filed on Aug. 1, 2003.

(51) Int. Cl. G06F 17/60

(52) U.S. Cl. 705/10

(57) ABSTRACT

In general, the relative effectiveness of different objects may be determined by determining comparative values to be associated with a first and second object that has been rendered in an online environment, wherein the comparative values reflect user activity related to online interactions with the objects. An impression count may be determined for the objects that reflect a number of opportunities made available to users to perceive the objects within the online environment. Relative effectiveness measures for the first object and the second objects may be determined based at least in part on the comparative values and the impression counts to enable comparison of the relative effectiveness measures for the first and second objects.

### CROSS-REFENCE TO RELATED APPLICATIONS

The application claims priority to U.S. Provisional Application No. 60/492,117, filed Aug. 1, 2003, which is incorportated by reference in its entirety.

### TECHNICAL FIELD

This document relates to establishing the effectiveness of online objects, such as online advertisements.

### BACKGROUND

Communications networks, such as the Internet, may be used to realize new opportunities for organizations.

### DESCRIPTION OF DRAWINGS

FIG. 1 illustrates a graphical user interface (GUI) representing an exemplary advertisement that may be presented to a user.

FIG. 2 illustrates a GUI representing an exemplary web page that may be presented to a user in response to the user selecting an advertisement.

FIG. 3 illustrates a GUI representing an exemplary web page that a user completes to purchase a subscription.

FIG. 4 illustrates terms of an exemplary agreement that may be entered into between operations of a primary host and an intermediary host.

FIG. 5 illustrates an exemplary report that makes perceivable the relative effectiveness of advertisements.

FIG. 6 illustrates a block diagram of an exemplary communications network configured to enable an intermediary host to place advertisements for a primary host.

FIG. 7 is a flow chart of an exemplary process by which determines relative effectiveness of an object is determined.

FIG. 8 is a flow chart of an exemplary process by which placements of advertisements through the use of relative advertising effectiveness data is managed.

FIG. 9 is a flow chart of an exemplary process by which an intermediary host places advertisements and executes transactions on behalf of the primary host.

### DETAILED DESCRIPTION

The advent and popularity of communications networks, such as the Internet, presents dramatic opportunities to bring together diverse parties. For example, a business may conduct operations over the Internet using a primary host to enable access to premium content for a subscription fee, sell products to users, act as a logistics support tool, and/or conduct information mining operations (e.g., conduct surveys or develop a database). Leveraging communications networks in this and other manners, businesses can deliver online advertisements, such as banner ads and popup ads, to wider audiences with improved effectiveness.

An intermediary party may advertise on behalf of a business and the business's primary host. For instance, the intermediary party that is equipped with relatively sophisticated tools (e.g., software) may target advertisements to a particular user/demographic/geography, use detailed reporting tools to reflect advertisement reach and/or effectiveness, develop market power/presence, and identify and provide an ability to publish content at otherwise unavailable sites that “draw” a large or product/service appropriate Internet audience. The intermediary party may use an intermediary host to advertise on behalf of the primary host operated by the business. For example, the intermediary host may execute transactions enabling access to premium subscription content located on the primary host. The intermediary host may place an advertisement designed to elicit a user response, present a transaction page when the user responds to the advertisement (e.g., by “clicking” on the advertisement), execute the transaction when the user elects to purchase a subscription, and/or activate an account on the primary host for the user.

One challenge is that there is a limited inventory of impressions (e.g., opportunities for advertisements to be placed) that are available to provide advertisements. Not only is the overall inventory limited, but the inventory is more constrained with respect to particular types of impressions that are available. For example, a banner ad featured on the top of a popular web page may be considered the most desirable advertisement because of the prominence of the banner ad in the display. The prominence (e.g., size) also limits the frequency at which a banner ad can be displayed relative to smaller ads that may be displayed in greater numbers elsewhere in a web page. Other factors limiting the inventory may include the time of day at which an advertisement may be placed, or on which page the advertisement is placed.

A first model of placing advertisements involves an advertisement publisher charging per impression or per type of impression (e.g., a cost-based system). While a cost-based system generally provides some form of guaranteed revenue for placement by the intermediary host, a system that only uses costs faces a number of challenges. First, a primary host may be reluctant to engage in advertising because of the uncertainty over results. In particular, the effectiveness or relative effectiveness of a particular advertisement is neither guaranteed nor even considered when establishing fees under such a model. And second, the motivation on the part of the intermediary host to ensure success may be less than the motivation to ensure that all available impressions are sold. This may lead to less than optimal placement of advertisements and allocation of impressions.

A second model involves the primary host and the intermediary host sharing in the successful placement of advertisements. In particular, the primary host and the intermediary host may agree to an incentivized plan where the intermediary host and the primary host realize revenues per successful impression. For example, the intermediary host may receive a commission or share of the revenues realized through placement of advertisements by the intermediary host.

In this second model, the intermediary host is incentivized to place advertisements that lead to successful transactions for the primary host. Thus, an intermediary host typically will favor allocating impressions for advertisements associated with greater revenues per impression rather than advertisements associated with the lower revenue per impression, particularly where the intermediary host accounts for the limited nature of impression availability.

In order for the intermediary host to favor advertisements based on revenue per impression a comparative value is determined for two or more online advertisements. For example, the revenues associated with two advertisements are determined as is an impression count for the two advertisements. A relative effectiveness measure for each of the two advertisements then is derived by relating the revenue with the impression count for each respective advertisement. In this, manner, it is possible to derive relative effectiveness measures that enable comparisons of advertisement effectiveness, such as, for example, a measure of the revenue realized per thousand impressions of each particular advertisement. The relative effectiveness measures of the advertisements or comparisons therebetween or rankings derived there from, may be displayed or otherwise made perceivable to enable comparison of advertisements.

Accordingly, an intermediary host may use a reporting system that enables comparison of different degrees of effectiveness. With the comparison, the advertising inventory may be allocated. For example, a manager may specify a relative frequency at which different advertisements are placed. Similarly, an automated agent may use the relative effectiveness measures to program placement of advertisements.

Moreover, application of these concepts based on metrics other than or in addition to revenue (e.g., click-through) may enable the comparison of items other than online advertisements (e.g., surveys) or to inform comparisons of such online advertisements.

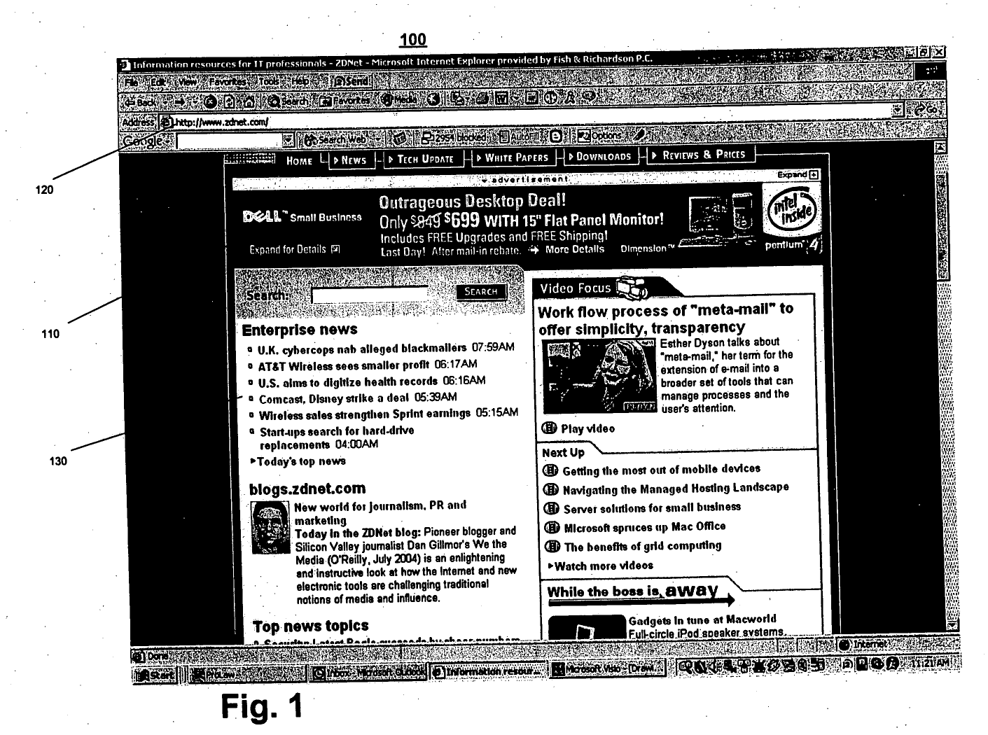

FIG. 1 is a GUI 100 illustrating an exemplary advertisement 110 that may be presented to a user. In particular, an intermediary host may select advertisement 110 from a pool of available advertisements using effectiveness ratings that indicate a measure of normalized revenue previously realized by placing the selected advertisement, such as the revenue realized per thousand impressions mentioned previously.

As shown, GUI 100 illustrates a web browser that has loaded a web page with advertisement 110. In particular, the GUI 100 shows an Internet Explorer application that has loaded www.zdnet.com as the web page (as indicated by the address field 120) and has included a banner advertisement (advertisement 110) across the banner of the www.zdnet.com web page. The remainder of the web page includes links to articles offered by and appearing in the www.zdnet.com web page, or other advertisements or content rendered therewith or placed thereon.

The advertisement 110 includes a code segment that allows user interaction with the advertisement 110 to trigger a transaction. For example, when the user clicks on or selects the advertisement (e.g., a click through), a different web page may be launched or invoked so that a user may undertake addition actions responsive to the source or object of the advertisement. Examples of the actions that may be launched as a result of selecting the advertisement may include, but are not limited to, presentation of additional information, presentation of a transaction screen leading to the actual purchase of a product and/or service (e.g., a subscription), and/or enrollment in a survey or database.

Although the GUI 100 shows a banner advertisement, other forms of advertisements may be used that feature different types of advertising. For example, instead of a banner advertisement embedded in the top of the screen, the intermediary host may use the web page to launch a popup advertisement appearing in a different web page. Moreover, other forms of advertisements may include a text-linked, pop-up or pop-under advertisements, animated or still advertisements that are superimposed over the underlying web page or that otherwise are not restricted to the boundaries of an underlying web page or advertisement space thereon and audio or video advertisements rendered in a media player (e.g., a Windows Media Player, or a Real Networks Media Player).

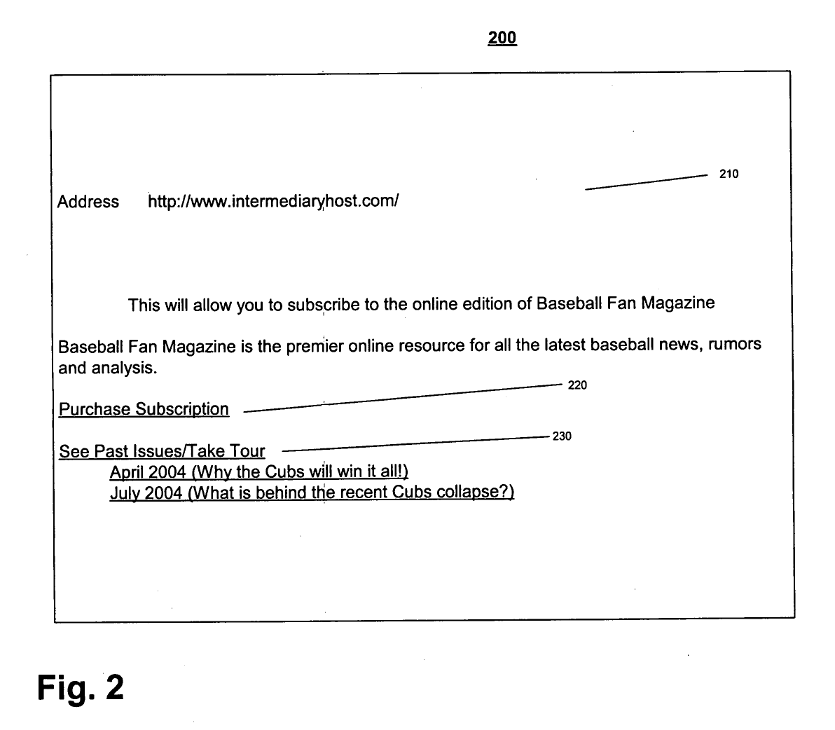

FIG. 2 is a GUI of an exemplary web page 200 that may be presented to a user in response to the user selecting an advertisement (e.g., advertisement 110 in FIG. 1). In particular, a user is presented with information indicating that web page 200 may be used to subscribe to the online edition of Baseball Fan magazine. The user may select a “purchase subscription” link 220 in order to access a web page configured to execute a financial transaction.

Web page 200 also includes a tour link 230 that allows the user to get a better sense of the product or service being offered. In the example shown, tour link 230 includes the April 2004 and July 2004 issues of Baseball Fan magazine.

Although web page 200 offers the look and feel of Baseball Fan magazine and may be used to complete a transaction to purchase a subscription to Baseball Fan magazine, in the example shown, Baseball Fan magazine is being hosted on a non-Baseball Fan magazine web page at the intermediary host (e.g., www.intermediaryhost.com).

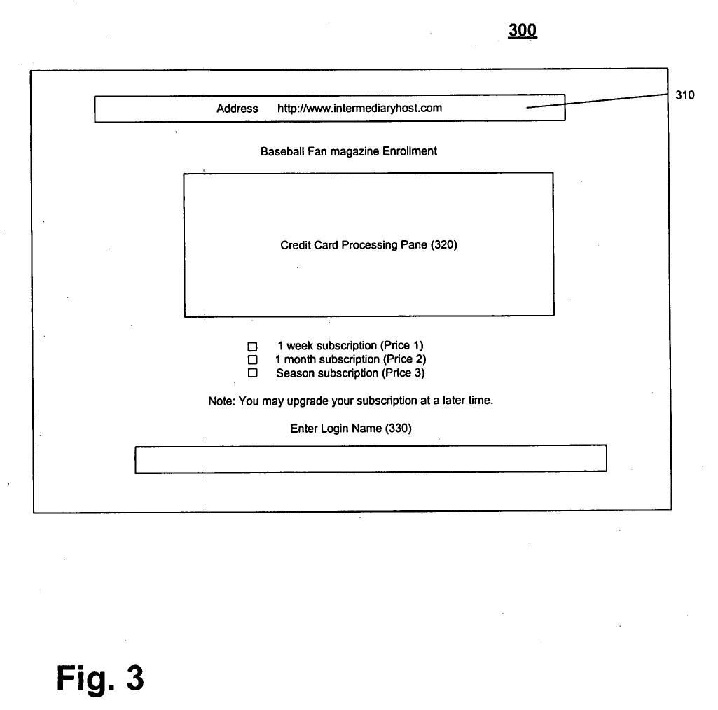

FIG. 3 is a GUI of an exemplary web page 300 that a user completes to purchase a subscription. Web page 300 is an example of the pane that may be presented to a user in response to the user selecting an advertisement (e.g., advertisement 110 in FIG. 1 or link 220 in FIG. 2). As shown, web page 300 includes an address pane 310, a credit card processing pane 320, and a login pane 330.

The address field 310 indicates that the web page 300 was generated from an intermediary host, in this case www.intermediaryhost.com/ for Baseball Fan magazine. By entering the payment at an intermediary host, rather than at the primary host, the intermediary host operator may reduce the likelihood of fraudulent reporting and/or reporting errors that may occur with respect to revenue in a system where the primary host operates the financial transaction system. Regardless, the web page 300 may be operated by an entity/organization and use a configuration that differ from those of the intermediary host described above. For example, a mirrored site may be presented by an intermediary host as if the primary host were presenting the web site (e.g., the intermediary host may present www.baseballfanmagazine.com). In one instance, the web page 300 is operated by a primary host configured with a trusted code segment that reports revenues back to the intermediary host. In a second instance, intermediary host presents web page 300, and directs the transaction to an online banking host acting as an Internet Payment Service Provider (IPSP) to process the transaction and/or report revenues. In yet another instance, the web page 300 is presented by the IPSP in response to a referral by the intermediary host (e.g., from web page 200). The referral to the IPSP may include a post-back code so that the intermediary host is credited when the transaction is executed.

The credit card processing pane 320 allows a user to enter payment information to execute a transaction. Although a credit card processing pane 320 is shown, other payment systems may be used. For example, an electronic wallet, a trusted payor system, a proxy paying agent, a prepaid account, and/or gift certificate may be used to execute a transaction. Other user actions may not require a financial transaction, or require a financial transaction involving user payment, such as when a user is asked to complete a survey.

The user is asked to select a product/plan from a list of plans. In particular, the user is asked to select a one-week subscription offered at price 1, a 1-month subscription offered at price 2, and a season subscription offered at price 3. The user also is notified of their ability to upgrade their subscription at a later time. Notably, upgrading a subscription may allow a user to take advantage of favorable pricing associated with a different product/plan in the future, affecting revenues otherwise resulting from their present selection of a plan. This may in turn adjust the revenues that are used to determine advertisement effectiveness. Thus, when the terms of the transaction are changed (e.g., through a user upgrade, reporting of fraud or user error, or refunds), the changes may be automatically reported to the financial transaction system that executed the transaction (e.g., a credit card processing system that executed a credit card transaction) as a mechanism for adjusting revenue calculations for an advertisement used to initiate the transaction being upgraded.

The login pane 330 enables the user to specify an identity, login name, or user account that will be used to subsequently access a product or service offered on the primary host. For example, the user may specify a login name and password that will be used to access a subscription service (e.g., Baseball Fan magazine). By enabling the user to specify a login name and password, the intermediary host may be configured to establish an account on behalf of the user on the primary host. Although login pane 330 is shown enabling the user to specify the identity, other configurations may inform the user of a login name provided by the intermediary host and/or primary host.

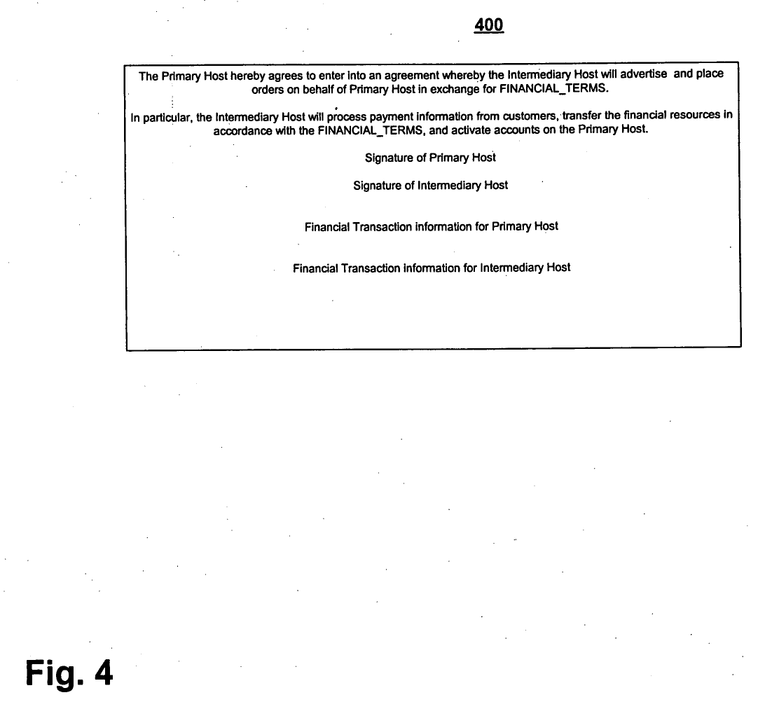

FIG. 4 is an exemplary agreement 400 that may be entered into between a primary host and an intermediary host. In particular, the agreement 400 provides that the intermediary host will advertise, and place orders on behalf of the primary host as provided for in the FINANCIAL_TERMS. Examples of the FINANCIAL_TERMS may include a fixed fee per sale, or a revenue sharing agreement. The agreement 400 also indicates that the intermediary host will process payment information from customers, transfer the financial resources in accordance with the FINANCIAL_TERMS, and activate accounts on the primary host. The agreement 400 is signed by a representative for the primary host and the intermediary host. As shown, the agreement 400 also includes financial transaction information for each of the parties so that funds may be electronically transferred in order to simplify the realization of resources.

In one instance, the agreement 400 represents an actual document manually signed by each of the parties. In another instance, the agreement 400 represents an electronic configuration that may be used to automatically configure the advertising placement process. For example, a representative of the primary host may complete agreement 400 as a web-based form in order to initiate the advertising placement operations.

In one implementation, the agreement may be electronically modified (e.g., the FINACIAL_TERMS are altered by increasing or decreasing a revenue sharing rate). Thus, instead of offering 50% revenue sharing, a business operating a primary host may offer 60% revenue sharing or a larger fixed feed per transaction to increase the incentives for an intermediary host to act on behalf of the primary host. Electronically modifying the agreement may propagate changes throughout a communications network. The increased revenue sharing may lead the intermediary host to offer more impressions, or change the type of the advertisement from reduced prominence (e.g., a small text link) to larger prominence (e.g., a banner ad). In particular, modifying the terms of the agreement may modify the relative effectiveness metrics (e.g., RPMs) used in deciding which advertisements to place. While a modification to an electronic agreement may be communicated automatically and update comparative effectiveness measures in response, the changes may experience a delay before the configuration change is implemented. For example, advertisements may be offered under the previous agreement. Advertisements leading to transactions placed under the previous agreement and executed before the modification is propagated may lead to a transaction being executed under the terms of the old agreement. Alternatively, the transaction may be retroactively adjusted to account for modifications to an agreement.

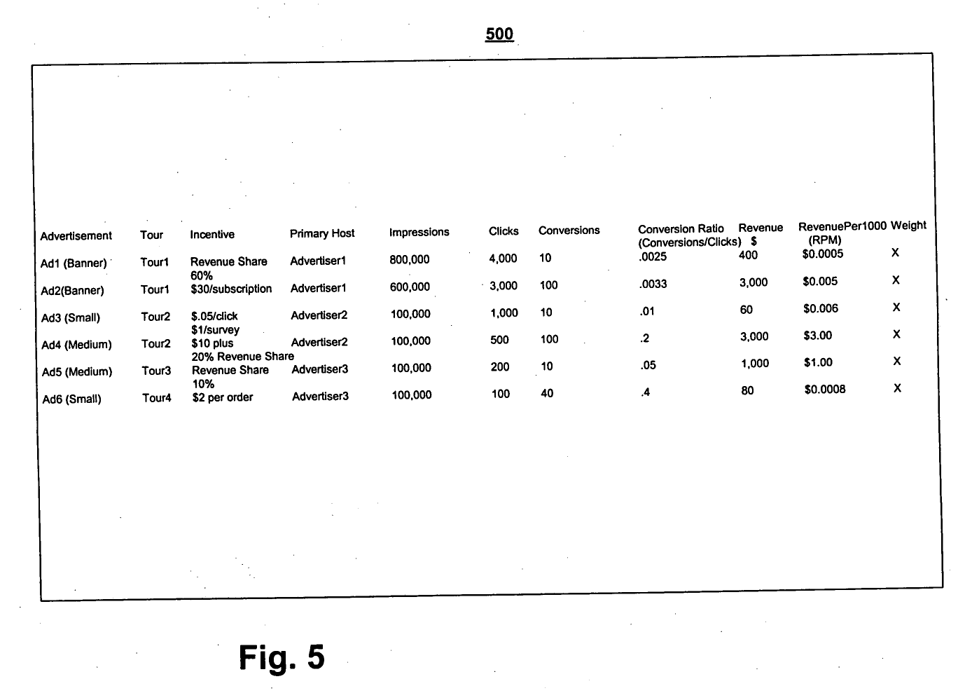

FIG. 5 is an exemplary report 500 that presents the relative effectiveness of advertisements. By presenting the relative effectiveness of advertisements, a manager (e.g., a human operator planning an advertising campaign or a software agent programming an advertisement distribution plan) may ascertain which advertisements realize the most revenue per impression. To illustrate how advertisements may be evaluated and/or sorted, the advertisements may be sorted by effectiveness. For example, the advertisements may be sorted by RPM metrics. With the advertisements sorted by RPM, the lowest performing RPM metrics may be removed. In one instance, advertisements with a metric less than a specified effectiveness value (e.g., RPM) are removed. In another example, an intermediary host may remove a specified number of the lowest performing advertisements, or a specified number equal to the number of new advertisements to be placed. The effectiveness data also may be used to remove advertisements that are least effective and promote increased viewing of more effective advertisements. In one instance, report 500 represents a GUI that is presented to a user, while in another instance, report 500 represents a configuration used by a database to program an advertisement distribution plan (e.g., advertising campaign).

Report 500 includes data related to six advertisements. Each advertisement is associated with a tour (e.g., web page 200), a description of the incentive, the identity of the primary host, the impression count, the number of clicks (e.g., a user selection action to investigate an advertisement further), the number of conversions (e.g., a user selection action to purchase a good or service or undertake an advertised course of action), a conversion ratio, the revenue realized (e.g. an aggregation of all revenues realized through all impressions rendered or some subset thereof, the revenue per 1,000 (Millis) impressions (RPM), and the weight (the relative frequency of impressions per advertisement). Generally, a conversion describes the operation whereby a user elects to purchase an advertisement.

Ad1 is associated with a revenue sharing incentive (60% as shown). Ad1 is a banner ad with 800,000 impressions, 4,000 clicks, 10 conversions, a conversion ratio of 0.0025, revenue of $400, and a RPM of $0.0005. Ad2 also is a banner advertisement and the intermediary host receives $30 per subscription. Ad2 is associated with 600,000 impressions, 3,000 clicks, 100 conversions, a conversion ratio of 0.0033, revenue of $3,000, and a RPM of $0.005. Ad3 is a small advertisement and the intermediary host receives $0.05 per click and $1 per survey. Ad3 is associated with 100,000 impressions, 1,000 clicks, 10 conversions, a conversion ratio of 0.01, revenue of $60, and a RPM of $0.006. Ad4 is a medium-sized advertisement and the intermediary host receives $10 per transaction and 20% of the revenues realized through the transaction. Ad4 is associated with 100,000 impressions, 500 clicks, 100 conversions, a conversion ratio of 0.2, revenue of $3,000, and a RPM of $3. Ad5 also is a medium-sized advertisement and the intermediary host receives a revenue percentage of 10% on all revenues realized through the referred transactions. Ad5 is associated with 100,000 impressions, 200 clicks, 10 conversions, a conversion ratio of 0.05, revenue of $1,000, and a RPM of $1. Ad6 is a small advertisement and the intermediary host receives a fixed fee of $2 per order realized through the referred transactions. Ad6 is associated with 100,000 impressions, 100 clicks, 40 conversions, a conversion ratio of 0.4, revenue of $80, and a RPM of $0.0008.

The report 500 can be sorted by the different columns to present the data in the most meaningful manner. As shown, the advertisements are sorted by the number of impressions. In another configuration, report 500 may be sorted by RPM values to better reveal the comparative effectiveness. Yet another configuration may sort by clicks or conversion ratio to better understand how users respond the advertisements, as measured by the number of clicks and/or conversion ratio.

The report 500 may be configured to enable a user or a software agent to specify the relative weight of advertisements. The specified weight values as applied to the unweighted effectiveness metric (e.g., RPM), and the resultant weighted RPM metrics then are compared to select and place advertisements.

A number of weighting systems may be used, or the weights may be used in a number of different manners. Ads may be weighted differently to reflect differing priorities in how an advertisement is used. In one instance, the weights are used to specify the frequency at which an advertisement is placed. In another instance, the weight is used to specify a priority for an advertisement. Thus, an advertisement with a higher weight may placed on a more favorable underlying web page, or receive a better placement (e.g., as a banner advertisement rather than a small advertisement). In one instance, a better placement of advertisements may be provided for those advertisements with the higher weights.

For the values shown in report 500, Ad4 may be deemed the most effective using the weighted RPM metric because the Ad4. Thus, when impressions are being allocated, Ad4 may be placed at a higher frequency than the other advertisements. In one implementation, the weights are added up, and the weight for each advertisement is compared against the total weighting to determine a ratio that is used to inform the relative frequency of advertisement placement. The intermediary server then may use a counting system to place advertisements at the appropriate frequency.

In an example where an intermediary host places two advertisements with weights of 5 and 4 in 72 impressions, the advertisement with a weight of 5 receives 40 of the 72 placements and the advertisement with a weight of 4 receives 32 placements. A software agent may be configured to manage counters so that for every nine requests/impressions, the advertisement with a weight of five is provided five times while the advertisement with a weight of four is provided four times.

Alternatively, or in addition, the allocation may be modified to reflect unique visits, use business logic, and/or accommodate other constraints. For instance, after a user has already visited the intermediary host and seen the advertisement having the highest weighted RPM metric, the intermediary host may place the second-most effective advertisement upon a return visit. During a third visit, the third-most effective advertisement may be displayed.

To illustrate, a software agent may manage a system of counters that indicate which user identities have visited a web site. When the user has not previously visited a web site, the counter is incremented and the user's identity is added to a list of identities that has previously visited the web site. Upon detecting a subsequent visit by the user identity, the intermediary server may decide to present a different advertisement since the user already has received the first advertisement. However, if the intermediary host has exhausted the supply of advertisements, or an elapsed time, as recorded by a log recording previous visits, or indicates that a threshold of time has elapsed since the previous visit, a previously presented advertisement may be presented again. This, in turn, may increment a counter associated with the user identity, and/or a counter tracking impressions.

In another instance, the advertisements may be weighted consistent using with relative RPM values that do not account for RPM differences. For example, although a first advertisement may have the highest RPM, the advertisement may be oriented towards certain demographics (e.g., known baseball fans or female audiences aged 18-32). When a user associated with a different demographic requests a web page offered by the intermediary host, the intermediary host may present the advertisement with the highest RPM for that demographic rather than the highest overall RPM. Presenting advertisements with the highest RPMs per demographic may be performed by filtering out those advertisements deemed not likely to be responsive, recalculating RPMs across different demographics (e.g., recalculating the RPM for those users perceived to be baseball fans) and/or adjusting the perceived effectiveness to reflect the likely interests of the demographic. Yet another instance may couple the selection criteria to known product inventories. When inventory information reveals that supply of a desired product is exhausted, the intermediary host may stop presenting advertisements for the exhausted product.

A software agent may track presentation of advertisements with respect to metrics configured to identify problematic conditions, such as ineffectiveness and/or overexposure. In one instance, overexposure is identified when the conversion ratio drops below a predetermined threshold. In another instance, overexposure is identified when the click-through ratio drops below a specified value, or when the conversion ratio and the click-through ratio both drop below specified values. In yet another instance, overexposure is identified when a software agent determines that an advertisement has been presented to a user identity more than specified number of times, has been presented to a community/demographic more than a specified number of times, and/or has been presented to more than a specified percentage of a community/demographic.

By identifying ineffective advertisements and/or overexposure, advertisement/brand diminution may be avoided, or managed to reduce the degree of ineffectiveness or overexposure. For example, if overexposure is associated with providing an advertisement to a user identity more than a specified number of times per time period, placement of the advertisement may be managed so that the advertisement is not placed to a user on the brink of overexposure until the next time period has commenced. Instead, the advertisement may be placed with users not on the brink of overexposure, and other advertisements may be placed instead of the advertisement on the brink of overexposure.

An element within FIG. 5 may be expanded to enable display of more detailed information with respect to a particular entry. For example, a particular tour (e.g., Tour 1) may be selected to invoke a popup display. The popup display may show the comparative effectiveness measures for the tour itself and/or show the different comparative effectiveness measures for the pages that lead to the particular tour. Alternatively or in addition, a tour may be compared with other tours to compare the comparative effectiveness measures of the different tours.

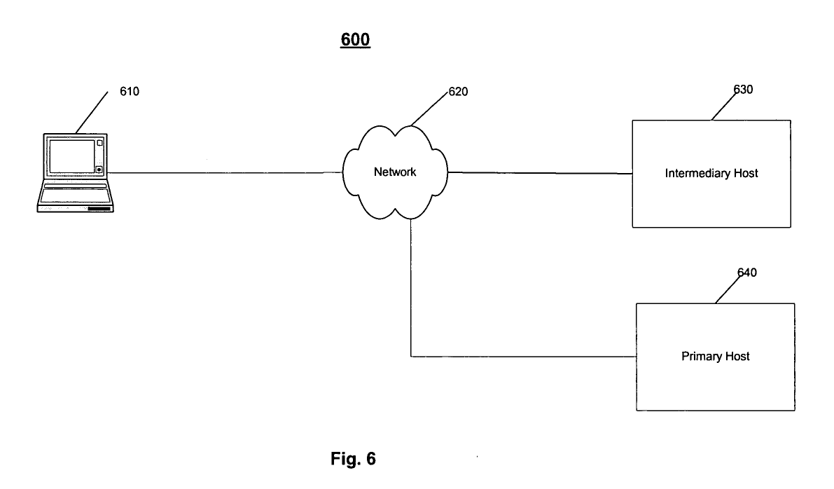

FIG. 6 illustrates a block diagram of an exemplary communications network configured to enable an intermediary host to place advertisements for a primary host.

The client 610 typically includes a computing device enabling a user to exchange information over a communications network. Typically, the client 610 includes one or more devices capable of accessing an intermediary host 630 and/or a primary host 640. The client 610 may include a controller (not shown) that processes instructions received from or generated by a software application, a program, a piece of code, a device, a computer, a computer system, or a combination thereof, which independently or collectively direct operations of the client 610. The instructions may be embodied permanently or temporarily in any type of machine, component, equipment, storage medium, or propagated signal that is capable of being delivered to the client 610 or that may reside with the controller at client 610. Client 610 may include a general-purpose computer (e.g., a personal computer (PC)) capable of responding to and executing instructions in a defined manner, a workstation, a notebook computer, a PDA (“Personal Digital Assistant”), a wireless phone, a component, other equipment, or some combination of these items that is capable of responding to and executing instructions.

In one implementation, the client 610 includes one or more information retrieval software applications (e.g., a browser, a mail application, an instant messaging client, an Internet service provider client), or an integrated client (e.g., a set top box or WebTV client) capable of receiving one or more data units. The information retrieval applications may run on a general-purpose operating system and a hardware platform that includes a general-purpose processor and specialized hardware for graphics, communications and/or other capabilities. In another implementation, client 610 may include a wireless telephone running a micro-browser application on a reduced operating system with general purpose and specialized hardware capable of operating in mobile environments.

The client 610 may include or access one or more media applications. For example, the client 610 may include a software application that enables the client 610 to receive and display an audio or video data stream. The media applications may include controls that enable a user to configure the user's media environment. For example, if the media application is receiving an Internet radio station, the media application may include controls that enable the user to select an Internet radio station, for example, through the use of “preset” icons indicating the station genre (e.g., country) or a favorite.

The network 620 typically includes hardware and/or software capable of enabling direct or indirect communications between the client 610, the intermediary host 630, and/or the primary host 640. As such, the network 620 may include a direct link between the client 610, the intermediary host 630, and/or the primary host 640, or it may include one or more networks or subnetworks between them (not shown). Each network or subnetwork may include, for example, a wired or wireless data pathway capable of carrying and receiving data. Examples of the delivery network include the Internet, the World Wide Web, a WAN (“Wide Area Network”), a LAN (“Local Area Network”), analog or digital wired and wireless telephone networks, radio, television, cable, satellite, and/or any other delivery mechanism for carrying data.

Typically, the intermediary host 630 and the primary host 640 include one or more general computing devices. Each general computing device generally includes one or more devices configured to distribute digital content. Typically, a general computing device includes a collection or library of content for distribution. Alternatively, or in addition, the general computing device may convert a media source (e.g., a video or audio feed) into a feed of data units for transmission across the network 620. The general computing device may include a general-purpose computer having a central processor unit (CPU), and memory/storage devices that store data and various programs such as an operating system and one or more application programs. Other examples of a general computing device include a workstation, a server, a special purpose device or component, a broadcast system, other equipment, or some combination thereof capable of responding to and executing instructions in a defined manner. The general computing device also may include an input/output (I/O) device (e.g., video and audio input and conversion capability), and peripheral equipment such as a communications card or device (e.g., a modem or a network adapter) for exchanging data with the network 620.

For instance, when the general computing device generally is capable of executing instructions under the command of a controller, the controller may be implemented by a software application loaded on the general computing device for commanding and directing communications exchanged with the client 610. Other examples of the controller include a program, a piece of code, an instruction, a device, a computer, a computer system, or a combination thereof, for independently or collectively instructing the general computing device to interact and operate as described.

The general computing device may be embodied permanently or temporarily in any type of machine, component, physical or virtual equipment, storage medium, or propagated signal capable of providing instructions to the general computing device.

Either or both of the intermediary host 630 and the primary host 640 may be configured to include a payment processor or code segment. Generally, a payment processor includes the systems and software configured to execute financial transactions and transfer resources between different parties (e.g., a user associated with client 610, or the businesses operating intermediary host 630 and primary host 640). The payment processor may be coupled to integrated financial systems used by banking institutions, and be configured to provide detailed reporting and accounting of expenditures and revenues.

In managing the transfer of resources, the payment processor may be configured to allocate financial resources consistent with an agreement (e.g., agreement 400 in FIG. 4 and/or the incentives in FIG. 5). Thus, when a financial transaction is executed, a portion of the revenue may be automatically transferred to the intermediary host 630 and/or the primary host 640. In one implementation, the intermediary host 630 forwards the revenues onto the primary host 640 (or vice-versa). In another implementation, a bank, acting as a trusted arbiter, allocates the resources upon execution of the transaction.

The intermediary host 630 may be configured to serve up content and also to act as an advertising server. In one implementation, the intermediary host 630 is a popular web server sought by consumers for providing relevant content. The intermediary host 630 may offer advertising services to realize additional revenues. In another example, the web server acts as an information clearinghouse that serves up information responsive to user searches, and/or presents a personal portal.

In order to provide the advertisements, the intermediary host 630 may present a general framework for a web page and adjust the advertising content on a flexible basis. For example, a requesting user may be associated with a baseball demographic, that is, a user likely to be responsive to baseball-oriented advertisements and content. Thus, when a user from the baseball demographic requests content, the intermediary host retrieves advertisements related to baseball. The advertisements related to baseball then may be incorporated into the web page presented to a user. In one implementation, the general framework is modified to generate different instantiations presented to a user where each instantiation includes one of several advertisements or advertising packages (e.g., multiple advertisement appearing in the web page) and each of the instances is directed to a different demographic. When the user requests a web page, the user's identity may be associated with a particular demographic in order to present the web page with the matching demographic. Alternatively, in response to a user request, the general template may be populated in response to a particular user request with advertisements.

Similarly, a web page may be presented for a previously-established demographic. For example, a user requesting a web page from a news site may be identified s belonging to a particular demographic (e.g., mothers aged 30-40). In response to the request, the intermediary host may provide a web page from the news site loaded with advertisements oriented towards the identified demographic (e.g., by presenting advertisements for children's toys for demographic of mothers aged 30-40).

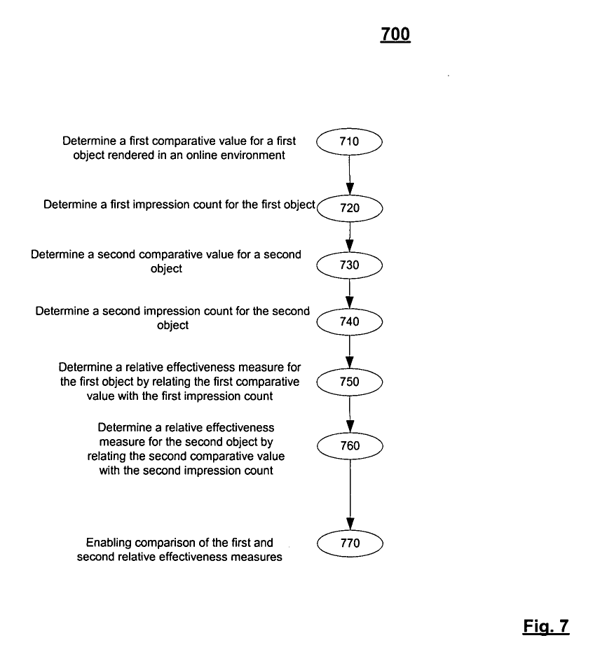

FIG. 7 is a flow chart of an exemplary process 700 by which the effectiveness of the an object is determined. For convenience, particular components and messaging formats described earlier are referenced as performing the process. However, similar methodologies may be applied in other implementations where different components are used to define the structure of the system, or where the functionality is distributed differently among the components shown.

Initially, a first comparative value for a first object rendered in an online environment is determined (710). Generally, determining the comparative value for the first object includes calculating the financial revenues realized through offering the first object. For example, an intermediary host may be offered a commission when an object (e.g., a banner ad appearing in a web page) presented to a user by the intermediary host leads to a purchase of goods or services by the user. In this example, determining the comparative value includes aggregating the different financial transactions to calculate the total revenues realized through offering the financial transaction. Examples of the commission structure may include offering a fixed fee per-transaction, a royalty or percentage of the transaction, and/or a hybrid of fixed fees and royalties.

Determining the comparative value also may include determining revenues that are realized through non-financial transactions on the part of the user. For example, the intermediary host may offer an object to solicit user completion of a survey. Completion of a user survey may not be considered to directly realize revenues since the user does not transfer resources as part of completing the survey. However, the primary host may nevertheless agree to pay the intermediary host to inspire user completion of the survey. Realizing the revenues for nonfinancial transactions may include calculating a per-completion incentive. Alternatively, or in addition, realizing the revenues for the nonfinancial transaction may include identifying subsequent sales of access to a database that includes the completed surveys.

A first impression count corresponding to the first object is determined (720). Generally, determining the impression count includes determining the number of times that the first object is rendered, or some subset thereof. For example, an intermediary host may determine the number of times that a particular object has been rendered (e.g., as a banner ad). In another example, an intermediary host may determine the number of times that a popup object was invoked from a gateway page.

The impression count may be adjusted to reflect the number of unique users or impressions. For example, a log may be used to track the IP addresses that access a web page. A server operated by the intermediary host providing the web page with the object may check to determine whether a client with the IP address has previously received the web page. When the client with the IP address has not previously received the web page, a counter tracking impressions for the first object may be incremented. When the client with the IP address has previously accessed the web page, the counter tracking impressions for the first object may not be incremented. By accounting for impressions to unique users, the intermediary host is incentivized to reach out to a larger audience rather than simply to provide the object at a higher frequency to an audience that has already seen an object, and perhaps deemed less likely to be responsive, having already been afforded the opportunity to accept an object.

Accounting for impressions to unique users may include identifying an IP address for a user identity before selecting an object, identifying a pool of available objects for the user, filtering out those objects not available to the user (e.g., by virtue of previous presentation or association with a nonresponsive demographic), and selecting an object determined to be “most useful” in realizing objectives. Examples of selecting the “most useful” object may include selecting an object with the highest weight, the object determined to be most likely to be responsive to a user's predicted interest, the object with the highest RPM, and/or the object that should be presented to maintain the specified frequency of placement.

Although identifying unique users was described using an IP address, other identification information (e.g., a screen name or a “cookie”) may be used to identify the user. Similarly, the unique users may be identified with respect to a period of time. Identifying unique users over a period of time may be used to account for the fact that some IP addresses may be reused, and to recognize that some users may represent continual traffic that consumes advertising inventory. By identifying a unique user with respect to time, the impact of user impressions with unique IP addresses and/or repeat users is better accounted for. In one example, user identities may be tracked over a 12-hour period.

Multiple counters may be used. For example, a first counter may be used to track impressions and responsiveness over a series of narrow time periods (e.g., 30 minutes). Another counter may be used to track impressions and responsiveness over a longer time period (e.g., one week). The counter for the longer time may be used to develop trends (e.g., which objects are becoming stale) while the counter for the shorter time period may be used to establish efficacy and user patterns with respect to time of day. Another counter may be used to track the number of times a unique user accesses the content, up to a threshold. Tracking the number of times a unique user accesses the content may be used to establish efficacy data with respect to exposure and also to track “brand awareness.” For instance, the efficacy data may reveal that “brand awareness” (as identified through surveys as recognition of a brand name or source identifier) is not established until a user experiences an average of three impressions while “trust” (as identified through surveys as user willingness to enter into a financial transaction) is not established until a user experiences an average of six impressions. Similarly, the efficacy data may reveal a distribution pattern that relates sales to impressions where the mean impression count per user occurs after a specified number of times (e.g., an average of seven impressions).

A second comparative value corresponding to a second object is determined (730), and a second impression count for the second object is determined (740). Generally, determining the second comparative value and the second impression count uses the metrics, operations, and systems described previously with respect to operations 710 and 720. The first and second objects are distinguishable on at least one basis. For example, the first and second object may offer a different product or service. In another example, the first and second object may offer the same product at two different prices. Other examples may include, but are not limited to, an object for the same product in a different advertising format (e.g., a banner ad vs. a small ad, a popup ad vs. a non-popup ad, an audio ad 1 vs. an audio ad 2, an audio format vs. a video format), a different theme (e.g., color scheme, theme), or a different underlying subject matter (e.g., breaking news vs. sports-related news).

A relative effectiveness measure for the first object is determined by relating the first comparative value with the first impression count (750), and a relative effectiveness measure for the second object is determined by relating the second comparative value with the second impression count (760). Examples of determining the effectiveness may include determining the revenue per millis (RPM) or revenue per impression (RPI). The frequency with which the revenue is compared may be modified so that the data is more readily understood from a business perspective. Moreover, when a large number of decimal places are used under a revenues per impression measure, such that value is difficult to understand in meaningful terms, the metric may be changed so that the value becomes more readily appreciable (e.g., by using RPM instead of RPI). Other examples of advertising effectiveness may include, but are not limited to, determining the revenues per targeted impression, revenues per impression of customers with “brand awareness” (e.g., by identifying those impressions associated with a user identity that has received an object at least the “brand awareness” number of times), revenues per impression with “trusting” customers (e.g., those users identified as willing to enter into a transaction based on identification of a prior relationship/transaction on the part of a user (a user associated with a previous purchase) or a user that received an object more than a threshold number of times), and/or revenues per impression with customers that have previous purchased the good or a related good or service. Hybrids of revenues and other metrics may be used. For example, the RPM may be modified to reflect or account for a cost incurred in providing the object. In particular, some transactions have different degrees of cost. A credit card processing system may be associated with a first cost, while a check paying system may be associated with a second cost. Accounting for the different costs used in executing a transaction may better inform a selection in deciding which object to place. A hybrid metric may provide profit per impression using revenue and cost information. Accordingly, an intermediary host may use a profit metric to maximize revenues by placing those objects yielding the highest profit per impression.

Comparison of the effectiveness of the first and second objects is enbabled. In comparing the effectiveness of the first and second objects, a manager may allocate object placement or use, that is, select which objects to place. In one instance, the manager selects how many times to place an object. In another instance, the manager selects a relative frequency at which the objects are used or rendered (e.g., the weight value shown in FIG. 5).

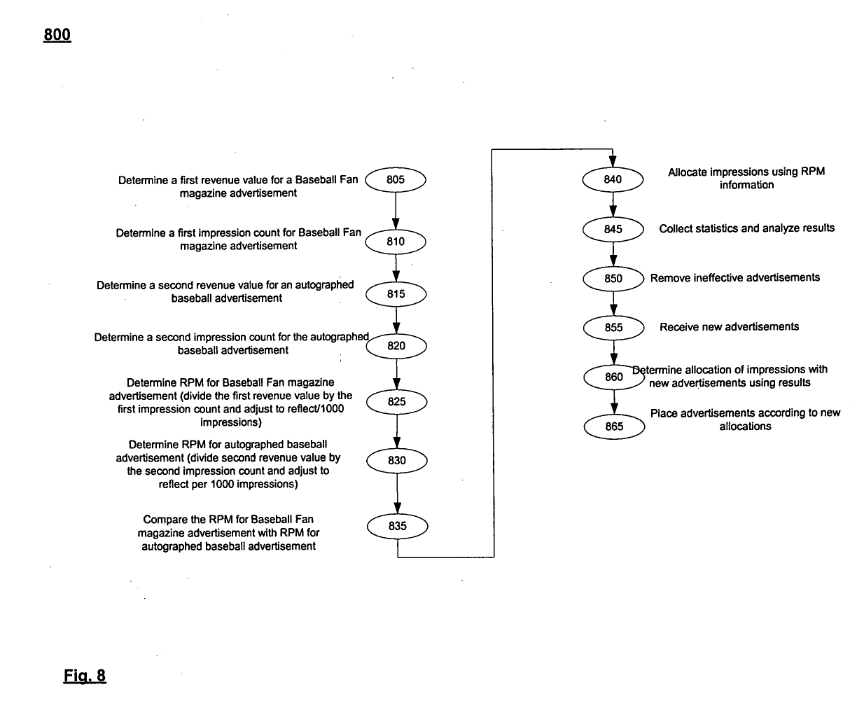

FIG. 8 is a flow chart of an exemplary process 800 by which placement of advertisements is managed through the use of advertising effectiveness data. For convenience, previously described components and messaging formats are referenced as performing the process. However, similar methodologies may be applied in other implementations where different components are used to define the structure of the system, or where the functionality is distributed differently among the components shown.

In the example shown, a manager operating an intermediary host determines whether and/or at which frequencies to place a first advertisement for Baseball Fan magazine versus a second advertisement for an autographed baseball. In making the decision, the manager determines the first revenue value (805) and impression count (810) for the Baseball Fan magazine advertisement and the second revenue value (815) and second impression count (820) for the autographed baseball. An RPM for Baseball Fan magazine is determined by dividing the first revenue value by the first impression count and adjusting the result to reflect revenue per thousand impressions (825). Similarity, a RPM for the autographed baseball is determined by dividing the second revenue value by the second impression count and adjusting the result to reflect revenue per thousand impressions (830). The RPMs for Baseball Fan magazine and the autographed baseball advertisements are compared (835). For example, the RPM for Baseball Fan magazine advertisement may be $0.10 per thousand impressions while the RPM for the autographed baseball may be $0.20 per thousand impressions.

Allocation of advertisement impressions then is performed using the results of the comparison (840).

In one implementation, a manager may manually select the weight at which the advertisements are compared. Thus, a manager may select a weight of 8 for the autographed baseball advertisement and 4 for baseball fan magazine so that the autographed baseball is advertised twice as often as the advertisement for Baseball Fan magazine.

A less than optimal allocation of weights may be used to comply with existing contractual relations. For example, in exchange for an exclusivity arrangement, a primary host may insist on placement of advertisements at a specified ratio, or a specified number of times (e.g., if volume is lower than expected).

The impressions may be allocated using other techniques. For example, the impressions may be allocated using algorithms that attempt to optimize the revenue realized. For instance, the weights may be set so that the advertisement is not overexposed, where overexposure is identified as the relative frequency at which an advertisement is shown. In another instance, a different weighting system may be used depending on the rate at which impressions are being generated. Thus, when the rate of impressions is lower than expected, the advertisement with the higher RPM may be displayed at a greater frequency to realize revenue targets. In contrast, when the rate of impressions is higher than expected, the advertisement with the higher RPM may be displayed at a lower frequency so that the advertisement with the higher RPM is not overexposed, and/or also to better realize marginal revenues from additional products. The additional products may be targeted for an untested product or uncertain marketplace and/or support a product not as susceptible to overexposure. Yet another system may attempt to promote “brand awareness” or “trust” within a specified time period for a particular user identity and to preserve the “brand awareness” or “trust” through an occasional or periodic “touch.” In such a system, the impressions may be allocated so as to establish the desired effect (e.g., establishment or maintenance of brand awareness and/or trust) within the specified time period (e.g., five impressions over three days but no impression more than once every two hours in those three days) for the advertisements with the better RPMs first, and place the second best advertisements in the remaining inventory in pursuit of objectives associated with the second best advertisements, continuing until the advertisement inventory is exhausted.

Alternatively, the weight may be used in a revenue projection system. In one example, when the effectiveness and/or revenues vary with the frequency of placement, adjusting the weight generates a display so that a manager may view projected revenue in response to the weighting. Similarly, the revenue projection tool may account for variations in effectiveness across different frequencies. Thus, when minimal exposure leads to the bulk of revenues (e.g., due to the multiplicative effects of word-of-mouth endorsements) while increased exposure only produces small marginal revenues, a revenue projection system may be used to present projected performance at different weights.

With the allocation of impressions completed and advertisements placed, statistics are collected and the results are analyzed (845). In one instance, RPM values are updated. New efficacy data may be established with respect to “brand awareness” and “trust.” In analyzing results, ineffective advertisements may be removed from an advertisement pool (850), and new advertisements may be received and added to the advertisement pool for placement (855).

In placing new advertisements, that is, advertisements without an established RPM, or a just-recently established RPM, the new advertisements may be related to a known profile and placed in accordance with the placement criteria for the known profile. For example, if the advertisement is for an autographed baseball bat, the RPM data for a previously run advertisement campaign for an autographed baseball may be used. Similarly, when the new advertisement is for a new magazine, the RPM for products and services perceived to be a similar demographic may be used until adequate data exists to constitute a valid sample size. Alternatively, or in addition, the new advertisement may be placed on a demonstration regimen believed to best introduce a new product. For example, if the advertisement was for a new class of products and it is unsure how the marketplace would respond to the advertisement/new class of products, an advertising campaign may be used that 1) establishes “brand awareness” and/or “trust”, 2) does not interfere placement of advertisements of products with the highest RPM (the most successful), and/or 3) is limited to a sample population to establish effectiveness metrics across one or more sample populations.

With the ineffective advertisements removed, new advertisements received, and new statistics/results determined, a new allocation of impressions is determined (860). For example, new weights or distribution criteria may be distributed. The advertisements are then placed according to the new weightings (865).

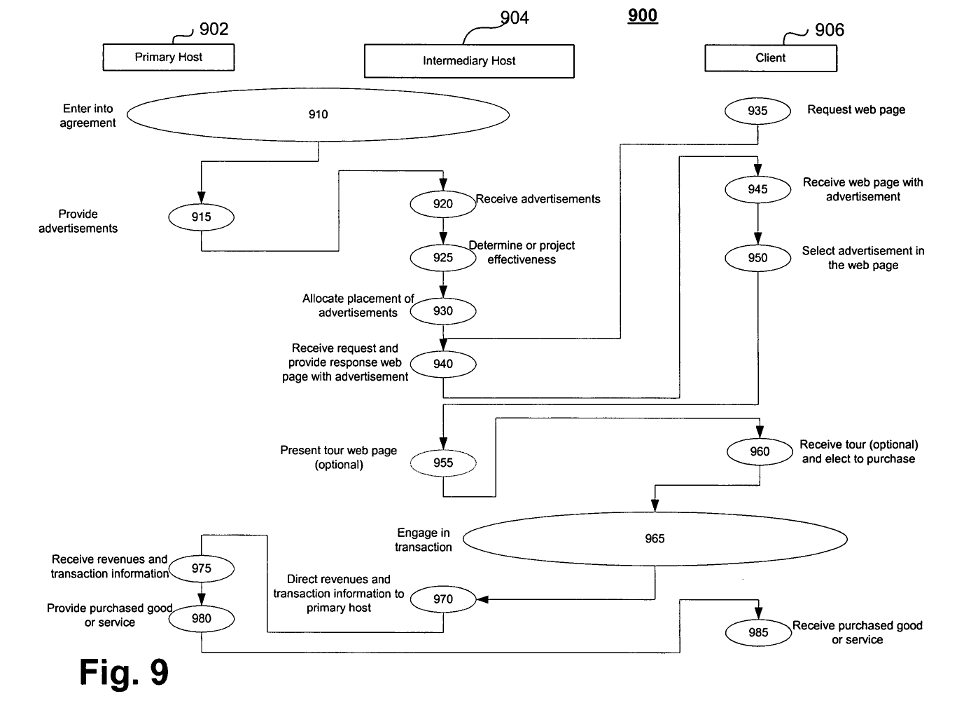

FIG. 9 is a flow chart of an exemplary process 900 by which an intermediary host 904 offers advertisements and executes transactions on behalf of the primary host 906. For convenience, particular components and messaging formats described earlier are referenced as performing the process. However, similar methodologies may be applied in other implementations where different components are used to define the structure of the system, or where the functionality is distributed differently among the components shown.

Typically, the primary host 902 and the intermediary host 904 initially enter into an agreement (910). For example, the primary host 902 and the intermediary host 904 may be configured to interface with one another through the agreement 400 shown in FIG. 4. Pursuant to the agreement, the primary host 902 provides advertisements to the intermediary host 904 (915), which receives the advertisements (920). The intermediary host 904 determines or projects effectiveness for the new advertisements (925). In one implementation, determining or projecting effectiveness includes relating the offered good or service to a similar good or service with an established profile and/or conducting preliminary sampling across one or more demographics.

The intermediary host 904 allocates placement of advertisements (930). Allocating placement of advertisements may include using the new advertisement with a specified weight when a user from predetermined demographic requests a web page hosted on the intermediary server 904.

The client 906 requests a web page (935). For example, the client 906 may retrieve a news page that provides breaking news. The intermediary host 904 receives the request and provides the response web page with the advertisement (940). Thus, the web page with breaking news may feature a banner advertisement. The client 906 receives the web page with the advertisement (945), and selects the advertisement in the web page (950). The intermediary host 904 then presents a tour web page (optional) (955). The client 906 receives the tour (optional) and elects to purchase the good (960). The intermediary host and the client 906 engage in the transaction (965). The intermediary host 904 directs revenues and transaction information to the primary host (970). The primary host 902 receives the revenues and transaction information (975), and provides the purchased good or service (980). The client 906 receives the purchased good or service (985). For example, the primary host 902 may ship a product to the client's address, or enable the client to access an online magazine.

Other implementations are within the scope of the following claims. Although many of the operations were described as being performed on a particular system, other systems may perform an operation. For example, the primary host was described as providing the advertisements, the intermediary host also may develop advertisements for the benefit of the primary host. Similarly, while the intermediary host was shown providing the tour web page and the primary host was shown providing the purchased good or service, in other implementations, the optional tour page may be provided by the primary host or the purchased good or service may be provided by the intermediary host (e.g., by offering a mirrored site of an online magazine).

The operations may be applied to evaluate the factors leading to optimal advertisement effectiveness. For example, an advertisement may be associated with different variables associated with the presentation and/or performance of the advertisement. Examples of the variables include, but are not limited to, background color, advertisement size, type color, type size, inclusion of one or more elements (e.g., graphics) within an advertisement, price points, revenue sharing incentives/percentages, and subject matter of a web page in which the advertisement appears. Different combinations of the variables may be used to generate different advertisements for a product or service. The different advertisements may be placed at a sampling frequency to determine the performance/effectiveness of the different combinations and also to determine the influence of a variable in the overall performance/effectiveness. Thus, an advertisement that features a product with a red background realizes a first RPM value and the same advertisement for the same product with a blue background realizes a second RPM value. Similarly, a large advertisement may realize a third RPM value while the small advertisement may realize a fourth RPM value. By evaluating the different variables, an advertisement may be generated and placed using the results of the different evaluations.

Although many of the operations were described with respect to advertisements, the operations described may be applied to objects in general. Examples of the objects may include, but are not limited to, web pages and messaging communications. In another example, the objects may include the background color on a web page (e.g., presenting a web page with a red background instead of a blue background), type (e.g., a small font vs. a larger font), content (e.g., articles about subject matter A vs. subject matter B). The different objects may be evaluated on the basis of effectiveness, such as RPM.

Although many of the operations were described with respect to an intermediary and primary host, the operations may be performed within a system. For example, a business operating a web page may use the effectiveness metrics to evaluate the performance of the different web pages operated by a web page. Similarly, in proprietary networks (e.g., a private data network and/or a wireless carrier network serving wireless appliances), the operations may be used to evaluate effectiveness of advertisements placed within the proprietary network. In one instance, a wireless carrier may determine the effectiveness of advertisements for products offered through the proprietary network (e.g., a specialized shopping system offering goods and services to wireless phones). The advertisements may be transmitted as SMS (Short Message Service) messages or other messaging communications, or the advertisement may be transmitted as a web or proprietary web page.

An entire object (e.g., a web page) or several components within an object may be selected to realize most effective results for the entire object, even if the constituent components are associated with less than optimal effectiveness. For example, a web page may be constructed to realize the highest possible RPM. While Ad1 and Ad2 may have the highest individual RPMs, using the combination of Ad3 and Ad 4 may yield a higher RPM than the combination of Ad1 and Ad2. Differences in performance between the constituent performance and the aggregated/combination performance may be due to the effect that constituent objects may have upon each other. For example, Ad1 and Ad2 may be substitutes for each other, thus the combination of Ad1 and Ad2 may result in competition for the underlying market. In contrast, Ad3 and Ad4 may be advertisements for complementary goods (e.g., Ad3 is for peanut butter while Ad4 is for jelly), and thus, offering advertisements for one of the constituent goods may lead to cross sales for the other good.

In one example, determining the most effective result for the entire object may be done by sampling different combinations, and evaluating the results. In another example, determining the most effective result includes relating the advertisement to a particular user demographic and/or product profile, and using a database of user demographic/product profile relationships to predict performance. The predicted performance may be updated with actual performance data, which may, in turn, update the database.

Placement for objects such as advertisements may be managed by structuring placements of objects into zones. In particular, each zone may include a programming construct that manages how an advertisement is place into the web page. A zone may include rules regulating what advertisements may be placed within an object and/or where an object may be placed. For example, a zone may include a rule indicating that the advertisement with the highest RPM should be placed in a zone. In another example, the zone may specify the demographic of the advertisement to be place, a size of the advertisement to be place, a subject matter (e.g., baseball), a type of advertisement to be placed (e.g., a tour link or survey link), a color of the advertisement to be placed, a revenue requirement (e.g., a minimum RPM), and/or a branding requirement (e.g., a product that the customer has “brand awareness” or “trust”). The zone may link back a database of objects and/or object state information (e.g., counters tracking impressions and meters tracking RPM) so that the zone may place advertisements responsive to the state of the object and/or user community.

In one implementation, the zone may be coupled to a payment processor so that if a vendor is unable to fulfill contractual obligations (e.g., fails to provide the agreed to revenue pursuant to a revenue-sharing agreement), advertisements for the party in breach will no longer be placed. In an advanced implementation, placement of advertisements for the party in breach may be replaced with advertisements for a competitive good. Thus, a rule may specify a “in breach” condition that includes a label identifying a class of goods and/or a competitor identity. When the payment processor indicates that a party is in breach of an agreement, a party reading a zone code may use the label to identify an alternative advertisement for placement.

The reporting tool may aggregate performance for multiple types of advertisements for a product. Thus, a RPM may be determined for autographed baseballs where the advertisements include banner ads, tours, text links, and smaller advertisements. The reporting tool also may aggregate performance for revenues that are related through the related purchase of goods. For example, if an advertisement is for baseballs and a user also purchase a glove and a baseball bat, the revenues include the revenues for the baseballs, the glove, and the bat. In such circumstances, the relative effectiveness metric of advertisements leading to revenues for multiple products may be greater than advertisements that do not lead to the purchase of related products.

1. A method of comparing the relative effectiveness of different objects, the method comprising:
determining a first comparative value to be associated with a first object that has been rendered in an online environment, wherein the first comparative value reflects user activity related to online interactions with the first object;
determining a first impression count for the first object that reflects a number of opportunities made available to users to perceive the first object within the online environment;
determining a second comparative value to be associated with a second object that has been rendered in an online environment, wherein the second comparative value reflects user activity related to online interactions with the second object;
determining a second impression count for the second object that reflects a number of opportunities made available to users to perceive the second object within the online environment;
determining a relative effectiveness measure for the first object based at least in part on the first comparative value and the first impression count;
determining a relative effectiveness measure for the second object based at least in part on the second comparative value and the second impression count; and
enabling comparison of the relative effectiveness measures for the first and second objects.

2. The method of claim 1 wherein determining the relative effectiveness measures for the first and second objects includes determining an effectiveness measure per impression or an effectiveness measure per number of impressions.

3. The method of claim 1 wherein determining the first comparative value or the second comparative value includes determining a revenue value realized through rendering the first object or the second object.

4. The method of claim 1 further comprising:
comparing the relative effectiveness of more than two objects related to a zone; and
selecting a subset of the objects related to the zone using the compared relative effectiveness of the objects.

5. The method of claim 1 wherein determining the first comparative value includes:
placing the first object;
enabling user interaction with the first object;
monitoring one or more financial transactions resulting from user interaction with the first object; and
determining the first comparative value by aggregating metrics related to the financial transactions.

6. The method of claim 5 further comprising executing the financial transaction.

7. The method of claim 6 further comprising fulfilling a request resulting from the user interaction with the first object.

8. The method of claim 7 further comprising activating an online subscription for a user in response to executing the financial transaction for the user.

9. The method of claim 7 further comprising communicating information reflecting aspects of the financial transaction to enable fulfillment of the financial transaction.

10. The method of claim 6 further comprising shipping a product in response to executing the financial transaction for the user.

11. The method of claim 1 wherein determining the first comparative value includes adjusting the first comparative value to account for fraud, a change in a subscription plan, a refund, a return, or an additional purchase.

12. The method of claim 11 further comprising adjusting the relative effectiveness measure in response to adjusting the comparative value.

13. The method of claim 11 further comprising identifying revenue related to fraud.

14. The method of claim 13 further comprising adjusting the relative effectiveness measure based on identifying the revenue related to fraud.

15. The method of claim 1 wherein determining the first comparative value includes quantifying a value metric for a non-financial transaction.

16. The method of claim 15 wherein determining the first comparative value includes normalizing the non-financial transaction with respect to other value metrics for other non-financial transactions.

17. The method of claim 15 wherein determining the first comparative value includes normalizing the non-financial transaction with respect to financial transactions.

18. The method of claim 17 wherein enabling comparison of the relative effectiveness measures for the non-financial and the financial transactions includes comparing the relative effectiveness measures based at least in part on a comparison of aggregated value metrics for the non-financial transactions and aggregated value metrics for the financial transactions.

19. The method of claim 15 wherein quantifying the financial value for the non-financial transaction includes quantifying the financial value for participating in a survey, participating in a tour, or participating in a trial offer.

20. The method of claim 15 wherein quantifying the value metric includes quantifying a value metric for selecting on an object.

21. The method of claim 1 wherein determining the first comparative value includes quantifying a value metric for a financial transaction.

22. The method of claim 1 wherein comparing the relative effectiveness measures for the first and the second objects includes distinguishing between two different objects for an object that is offered at different price points.

23. The method of claim 22 wherein distinguishing between the first and second objects includes displaying the different relative effectiveness metrics for the first and the second objects.

24. The method of claim 1 wherein comparing the relative effectiveness measures for the first and the second objects includes distinguishing between two different objects for an object presented in two different sizes.

25. The method of claim 1 wherein comparing the relative effectiveness measures for the first and the second objects includes distinguishing between one object presented in two different pages of differing subject matter.

26. The method of claim 1 wherein comparing the relative effectiveness measures for the first and the second objects includes distinguishing between one object invoked from two different gateway pages.

27. The method of claim 1 wherein determining the first impression count includes tracking an impression metric that is incremented in response to providing the first object to a user that has not previously received the first object.

28. The method of claim 1 wherein determining the first impression count includes tracking an impression metric that tracks how many times a user has received the first object.

29. The method of claim 1 wherein determining the first impression count includes tracking an impression metric that is incremented upon providing the first object irrespective of whether a user has previously received the first object.

30. A method of calculating effectiveness of an object, the method comprising,
using a trusted payment processor code segment to determine a comparative value for an object, wherein the comparative value relates to revenues that are realized through one or more online interactions with the object;
determining an impression count for the object; and
determining an effectiveness of the object by relating the comparative value to the impression count.

31. A system that compares the relative effectiveness of different objects, the system comprising:
a first comparative code segment structured and arranged to determine a first comparative value to be associated with a first object that has been rendered in an online environment, wherein the first comparative value reflects user activity related to online interactions with the first object;
a first impression code segment structured and arranged to determine a first impression count for the first object that reflects a number of opportunities made available to users to perceive the first object within the online environment;
a second comparative code segment structured and arranged to determine a second comparative value to be associated with a second object that has been rendered in an online environment, wherein the second comparative value reflects user activity related to online interactions with the second object;
a second impression code segment structured and arranged to determine a second impression count for the second object that reflects a number of opportunities made available to users to perceive the second object within the online environment;
a first effectiveness code segment structure and arranged to determine a relative effectiveness measure for the first object based at least in part on the first comparative value and the first impression count;
a second effectiveness code segment structured and arranged to determine a relative effectiveness measure for the second object based at least in part on the second comparative value and the second impression count; and
a comparison code segment structured and arranged to enable comparison of the relative effectiveness measures for the first and second objects.

32. The system of claim 31 wherein the first and second effectiveness code segments are structured and arranged to determine an effectiveness measure per impression or an effectiveness measure per number of impressions.

33. The system of claim 31 wherein the first and second comparative code segments are structured and arranged to determine a revenue value realized through rendering the first object or the second object.

34. The system of claim 31 further comprising a zone management code segment structured and arranged to:
compare the relative effectiveness of more than two objects related to a zone; and
select a subset of the objects related to the zone using the compared relative effectiveness of the objects.

35. The system of claim 31 wherein the first comparative code segment is structured and arranged to:
place the first object;
enable user interaction with the first object;
monitor one or more financial transactions resulting from user interaction with the first object; and
determine the first comparative value by aggregating metrics related to the financial transactions.

36. The system of claim 35 further comprising a transaction code segment structured and arranged to execute the financial transaction.

37. The system of claim 36 further comprising a fulfillment code segment structured and arranged to fulfill a request resulting from the user interaction with the first object.

38. The system of claim 37 further comprising an activation code segment structured and arranged to activate an online subscription for a user in response to executing the financial transaction for the user.

39. The system of claim 37 further comprising a proxy code segment structured and arranged to communicate information reflecting aspects of the financial transaction to enable fulfillment of the financial transaction.

40. The system of claim 36 further comprising a shipping code segment structured and arranged to ship a product in response to executing the financial transaction for the user.

41. The system of claim 31 wherein the first comparative code segment is structured and arranged to adjust the first comparative value to account for fraud, a change in a subscription plan, a refund, a return, or an additional purchase.

42. The system of claim 41 further comprising an adjustment code segment structured and arranged to adjust the relative effectiveness measure in response to adjusting the comparative value.

43. The system of claim 41 further comprising a fraud correlation code segment structured and arranged to identify revenue related to fraud.

44. The system of claim 43 further comprising a fraud effectiveness adjustment code segment structured and arranged to adjust the relative effectiveness measure based on identifying the revenue related to fraud.

45. The system of claim 31 wherein the first comparative code segment is structured and arranged to quantify a value metric for a non-financial transaction.

46. The system of claim 45 wherein the first comparative code segment is structured and arranged to normalize the non-financial transaction with respect to other value metrics for other non-financial transactions.

47. The system of claim 45 wherein the first comparative code segment is structured and arranged to normalize the non-financial transaction with respect to financial transactions.

48. The system of claim 47 wherein the comparison code segment is structured and arranged to compare the relative effectiveness measures based at least in part on a comparison of aggregated value metrics for the non-financial transactions and aggregated value metrics for the financial transactions.

49. The system of claim 45 wherein the first comparative code segment is structured and arranged to quantify the financial value for participating in a survey, participating in a tour, or participating in a trial offer.

50. The system of claim 45 wherein the first comparative code segment is structured and arranged to quantify a value metric for selecting on an object.

51. The system of claim 31 wherein the first comparative code segment is structured and arranged to quantify a value metric for a financial transaction.

52. The system of claim 31 wherein the comparison code segment is structured and arranged to distinguish between two different objects for an object that is offered at different price points.

53. The system of claim 52 wherein the comparison code segment is structured and arranged to display the different relative effectiveness metrics for the first and the second objects.

54. The system of claim 31 wherein the comparison code segment is structured and arranged to distinguish between two different objects for an object presented in two different sizes.

55. The system of claim 31 wherein the comparison code segment is structured and arranged to distinguish between one object presented in two different pages of differing subject matter.

56. The system of claim 31 wherein the comparison code segment is structured and arranged to distinguish between one object invoked from two different gateway pages.

57. The system of claim 31 wherein the first impression code segment is structured and arranged to track an impression metric that is incremented in response to providing the first object to a user that has not previously received the first object.

58. The system of claim 31 wherein the first impression code segment is structured and arranged to track an impression metric that tracks how many times a user has received the first object.

59. The system of claim 31 wherein the first impression code segment is structured and arranged to track an impression metric that is incremented upon providing the first object irrespective of whether a user has previously received the first object.

60. A system that calculates effectiveness of an object, the system comprising:
a trusted payment processor code segment structured and arranged to determine a comparative value for an object, wherein the comparative value relates to revenues that are realized through one or more online interactions with the object;
an impression code segment structured and arranged to determine an impression count for the object; and
an effectiveness code segment structured and arranged to determine an effectiveness of the object by relating the comparative value to the impression count.

61. A system that compares the relative effectiveness of different objects, the system comprising,
means for determining a first comparative value to be associated with a first object that has been rendered in an online environment, wherein the first comparative value reflects user activity related to online interactions with the first object;
means for determining a first impression count for the first object that reflects a number of opportunities made available to users to perceive the first object within the online environment;
means for determining a second comparative value to be associated with a second object that has been rendered in an online environment, wherein the second comparative value reflects user activity related to online interactions with the second object;
means for determining a second impression count for the second object that reflects a number of opportunities made available to users to perceive the second object within the online environment;
means for determining a relative effectiveness measure for the first object based at least in part on the first comparative value and the first impression count;
means for determining a relative effectiveness measure for the second object based at least in part on the second comparative value and the second impression count; and
means for enabling comparison of the relative effectiveness measures for the first and second objects.

62. A system that calculates effectiveness of an object, the system comprising:
means for using a trusted payment processor code segment to determine a comparative value for an object, wherein the comparative value relates to revenues that are realized through one or more online interactions with the object;
means for determining an impression count for the object; and
means for determining an effectiveness of the object by relating the comparative value to the impression count.
